(19) United States
(12) Patent Application Publication
(10) Pub. No.: US 2026/0308710 A1
(43) Pub. Date: Oct. 8, 2026

(54) PROCESS FOR THE EXTRACTION OF A BY-PRODUCT METAL FROM A MINERAL CONCENTRATE

(71) Applicant: FUNDACION TECNALIA RESEARCH & INNOVATION, DERIO - BIZKAIA (ES)

(72) Inventors: AINHOA UNZURRUNZAGA ITURBE, DONOSTIASAN SEBASTIAN (ES); LAURA SÁNCHEZ CUPIDO, DONOSTIA-SAN SEBASTIAN (ES); JOSE LUIS ALDANA MARTINEZ, DONOSTIA-SAN SEBASTIAN (ES); CARMEN DEL RÍO GAZTELURRUTIA, DONOSTIA-SAN SEBASTIAN (ES); GUILLERMO ALONSO POZO ZAMORA, DONOSTIASAN SEBASTIAN (ES); FRANCISCO JAVIER ANTOÑANZAS GONZÁLEZ, DONOSTIA-SAN SEBASTIAN (ES); EIDER MARTIN UGARTE, DONOSTIA-SAN SEBASTIAN (ES)

(21) Appl. No.: 19/482,583

(22) PCT Filed: May 10, 2024
(86) PCT No.: PCT/EP2024/062895

§ 371 Date: Nov. 7, 2025

(30) Foreign Application Priority Data
May 12, 2023 (EP) 23382453.1

(51) Int. Cl. C22B 3/16; C22B 3/06; C22B 3/08; C22B 3/10; C22B 3/22

(52) U.S. Cl. CPC C22B 3/1625; C22B 3/065; C22B 3/08; C22B 3/10; C22B 3/22

(57) ABSTRACT

A process for the extraction of a by-product metal from a mineral concentrate comprising a sulfide, selenide, or telluride mineral of the Cu—Ag—Au group. The process includes the steps of: a) providing a mineral concentrate comprising a sulfide, selenide, or telluride mineral of the Cu—Ag—Au group comprising by-product metals; b) contacting the mineral concentrate with a leaching solvent system comprising i) a deep eutectic solvent (DES) consisting of a mixture of a hydrogen bond acceptor (HBA) of Cat⁺X⁻ and a hydrogen bond donor (HBD) selected from ethylene glycol, triethylene glycol, and glycerol in a HBA:HBD molar ratio from 1:10 to 10:1; and ii) an additive selected from the H₂O₂, a strong inorganic acid, and a mixture thereof; in order to obtain a leachate containing the by-product metal in dissolution; c) separating the leachate from the undissolved mineral concentrate; and d) optionally, recovering the by-product metal from the leachate.

This application claims the benefit of the European Patent Application EP23382453.1 filed on May 12, 2023.

### TECHNICAL FIELD

The present invention relates to the field of extraction of metals from a mineral concentrate, in particular, to a process for extracting a by-product metal from a mineral concentrate with the use of a leaching solvent system comprising a specific Deep Eutectic Solvent (DES) and an additive.

### BACKGROUND ART

The availability of mineral resources is crucial for the technological development and economical activity in human society. Metals that do not form the primary product minerals are recovered as by-products during the processing of the main ore, that is, their host ore. However, the recovery of this “minor metals is often unable to respond to rapid changes in demand and, hence, there is an increasing concern regarding the reliability of supply for some of these by-product metals.

Thus, there is an interest in increasing the recovery efficiency of by-products metals which belong to the Cu—Ag—Au group from primary sources. This by-product metal elements are mainly tellurium (Te), selenium (Se), rhenium (Re), and molybdenum (Mo), as well as Critical Raw Materials such as bismuth (Bi), germanium (Ge), indium (In), cobalt (Co), platinum (Pt) and antimony (Sb).

Most of the mentioned by-product elements are used in environmental technologies, consumer electronics, health, steel-making, automotive, defense, space exploration, and aviation, and are deemed Critical Raw Materials (CRMs). CRMs are raw materials considered economically and strategically important for the European economy but have a high-risk associated with their supply.

Mahajan, V. B. et al. (cf. Mahajan, V. B. et. al. “Enhanced leaching of copper from chalcopyrite in hydrogen peroxide-glycol system”. Minerals Engineering, 2007, vol. 20. 670-674) disclose the dissolution of copper from chalcopyrite in the presence of hydrogen peroxide and ethylene glycol (EG).

Ruiz-Sánchez, Á. et al. (Ruiz-Sánchez, Á. et. al. “Improved Process for Leaching Refractory Copper Sulfides with Hydrogen Peroxide in Aqueous Ethylene Glycol Solutions: Proceedings of the First Global Conference on Extractive Metallurgy”. Extraction, 2018, pp. 1289-1298) disclose the extraction of copper and iron from chalcopyrite with solutions of hydrogen peroxide, ethylene glycol, and sulfuric acid, and, optionally, ethylenediaminetetraacetic acid (EDTA).

Petrovic, S. et al. (cf. Petrovic, S. et al. “Leaching of chalcopyrite with hydrogen peroxide in hydrochloric acid solution”. Transactions of Nonferrous Metals Society of China, 2018, vol. 28. 1444-1455) discloses the leaching of chalcopyrite concentrates with hydrochloric acid with hydrogen peroxide with the aim of recovering copper.

Carlesi, C. et al. (cf. Carlesi, C. et al. “Chemical Dissolution of Chalcopyrite Concentrate in Choline Chloride Ethylene Glycol Deep Eutectic Solvent”. Minerals. 2022, vol. 12. 65) disclose the recovery of copper and iron from a chalcopyrite concentrate by chemical dissolution of in a deep eutectic solvent.

The above mentioned documents of the prior art are addressed to the recovery of metals that form the primary product minerals such as copper and iron. No mention is made on the possibility of recovering by-product metals.

Therefore, from what it is known in the art, it is derived that there is still a need for a new cost-efficient mineral processing technology to recover metals that do not form the primary product minerals, i.e., by-product metals, from primary sources.

### SUMMARY OF INVENTION

The inventors have developed a process for the extraction of by-product metals from a mineral comprising sulfide, selenide, or telluride minerals of the Cu—Ag—Au group by using a leaching solvent system comprising a specific deep eutectic solvent (DES) in the presence of a specific additive, the process allowing to extract by-product metals in very high extraction yields.

Additionally, the process of the present disclosure has the advantage of having a lower environmental impact compared to the known processes. Besides, the use of low-cost reagents make it an interesting process as a substitute for other state of the art processes.

Hence, advantageously, the process of the invention provides a new mineral processing technology to jointly recover by-products from primary sources that belong to the Cu—Ag—Au group by means of innovative leaching solvent system. This leaching solvent system allows carrying out the process in conditions that help to make the process economically viable.

Finally, the process of the present invention has a very promising business potential since it allows mining and mineral processing companies to fully exploit their by-product potential by recovering them at their own facilities.

Therefore, an aspect of the present invention relates to a process for the extraction of a by-product metal from a mineral concentrate comprising a sulfide, selenide, or telluride mineral of the Cu—Ag—Au group, the process comprising the steps of:
a) providing a mineral concentrate comprising a sulfide, selenide, or telluride mineral of the Cu—Ag—Au group, wherein the sulfide, selenide, or telluride mineral comprises a by-product metal selected from the group consisting of Bi, Ag, Te, Se, Sb, Cd, In, Au, Ge, Co, Pt, Mo, and mixtures thereof;
b) contacting the mineral concentrate with a leaching solvent system comprising:
   i) a deep eutectic solvent (DES) consisting of a mixture of a hydrogen bond acceptor (HBA) of formula (I)

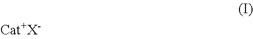

wherein
Cat⁺ is a cation selected from the group consisting of (2-hydroxyethyl)trimethylammonium (choline, Ch), ethyl(2-hydroxyethyl)dimethylammonium, benzyl(2-hydroxyethyl)dimethylammonium, bis(2-hydroxyethyl)dimethylammonium, benzyl-bis(2-hydroxyethyl)methylammonium, methyl(2-hydroxyethyl)diethyl-ammonium, (2-chloroethyl)trimethylammonium;
and X⁻ is an anion selected from the group consisting of F⁻, Cl⁻, Br⁻ and I⁻, and
a hydrogen bond donor (HBD) selected from ethylene glycol, triethylene glycol and glycerol;
wherein the HBA and the HBD are in a molar ratio from 1:10 to 10:1; and
ii) an additive selected from the group consisting of hydrogen peroxide (H₂O₂), a strong inorganic acid, and a mixture of H₂O₂ and the strong inorganic acid; in particular, wherein the strong inorganic acid is selected from the group consisting of hydrochloric acid (HCl), sulfuric acid (H₂SO₄), and nitric acid (HNO₃);
in order to obtain a leachate containing the by-product metal in dissolution;
c) separating the leachate from the undissolved mineral concentrate; and
d) optionally, recovering the by-product metal from the leachate.

Advantageously, by using the leaching solvent system of step b) it is possible to extract at least 50% w/w of a by-product metal from the mineral concentrate defined herein above and below.

Another aspect relates to a leaching solvent system comprising:
i) a deep eutectic solvent (DES) consisting of a mixture of a hydrogen bond acceptor (HBA) of formula (I)

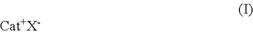

wherein
Cat⁺ is a cation selected from the group consisting of (2-hydroxyethyl)trimethylammonium (choline, Ch), ethyl(2-hydroxyethyl)dimethylammonium, benzyl(2-hydroxyethyl)dimethylammonium, bis(2-hydroxyethyl)dimethylammonium, benzyl-bis(2-hydroxyethyl)methylammonium, methyl(2-hydroxyethyl)diethyl-ammonium, (2-chloroethyl)trimethylammonium and X⁻ is an anion selected from the group consisting of F⁻, Cl⁻, Br⁻ and I⁻, and
a hydrogen bond donor (HBD) selected from ethylene glycol, triethylene glycol and glycerol;
wherein the HBA and the HBD are in a molar ratio from 1:10 to 10:1; and
ii) an additive selected from the group consisting of hydrogen peroxide (H₂O₂), a strong inorganic acid, and a mixture thereof; in particular, wherein the strong inorganic acid is selected from the group consisting of hydrochloric acid (HCl), sulfuric acid (H₂SO₄), and nitric acid (HNO₃).

### DETAILED DESCRIPTION OF THE INVENTION

All terms as used herein in this application, unless otherwise stated, shall be understood in their ordinary meaning as known in the art. Other more specific definitions for certain terms as used in the present application are as set forth below and are intended to apply uniformly through-out the specification and claims unless an otherwise expressly set out definition provides a broader definition.

As used herein, the term “by-product metals” refers to a metal (such as Bi, Ag, Cd, In, Au, Co, Pt, Mo) or metalloid (such as Ge, Te, Se, or Sb) that are found in relatively low concentrations such as from 0.9 wt. % to 0.001 wt. %, in which case these metal seldom form viable deposits of their own, but instead occur interstitially in the ores of metals with similar physical and chemical properties. Such metals are often considered to be impurities in ores containing metals in significantly higher concentration. Thus, minor metals are usually recovered only as by-products during processing of the “major metals” (also called “main metals”). Metals present in ore at significantly higher concentration are typically referred to as “major metals” and include, for example, copper (Cu), iron (Fe), zinc (Zn), and lead (Pb).

As used herein, the term “sulfide, selenide, or telluride minerals of the Cu—Ag—Au group” refers to minerals where extraction target metals are Cu, Ag, and Au. Examples of these sulfide, selenide, or telluride minerals include, without being limited to, hessite (AgTe₂), tetrahedrite ((Cu,Fe)₁₂Sb₄S₁₃), wittchinite (CuBiS₄), and chalcopyrite (CuFeS₂). It is understood that other sulfide, selenide, or telluride minerals that do not contain these main products elements (Cu, Ag, Au), but contain other elements such as Pb, Fe, or Zn (which are in high concentrations, such as galena (PbS), pyrite (FeS₂), and sphalerite (ZnS)), as well as other minerals containing elements that are considered by-products due to their low concentration (such as Bi, Te, Sb, and so on, as is the case of pilsenite (Bi₄Te₃) or aleksite (PbBi₂Te₂S₂), or bismuthinite (Bi₂S₃)) can be present in the primary sources belonging to the Cu—Ag—Au group.

As used herein, the term “extraction” of metals, such as by-product metals or accompanying major metals, is to be understood as a dissolving or leaching process by which the metal is extracted from a solid starting product, in particular a mineral concentrate, into a liquid, in this case the leaching solvent system used for the extraction. The leaching process can be described as the process by which constituents of solid material are released into a contacting solvent under a set of chemical phenomena, which may include mineral dissolution, desorption and complexation, and mass transport processes. In turn, these phenomena are affected by certain factors that can alter the rate or extent of leaching, such as, for example, the solvent used or the operating conditions.

As used herein, the indefinite articles “a” and “an” are synonymous with “at least one” or “one or more.” Unless indicated otherwise, definite articles used herein, such as “the” also include the plural of the noun.

As mentioned above, an aspect of the invention relates to a process for the extraction of a by-product metal from a mineral concentrate comprising a sulfide, selenide, or telluride mineral of the Cu—Ag—Au group, the process comprising the steps of contacting the mineral concentrate with a leaching solvent system comprising a deep eutectic solvent (DES) as defined above and an additive that can be hydrogen peroxide (H₂O₂), a strong inorganic; or a mixture of H₂O₂ and the strong inorganic acid; and separating from the undissolved mineral concentrate the obtained leachate containing the by-product metal in dissolution. Subsequently, the by-product metal can be recovered from the leachate.

In an embodiment, of the process of the present disclosure, the strong inorganic acid is selected from hydrochloric acid (HCl), sulfuric acid (H₂SO₄), and nitric acid (HNO₃). In particular, the strong inorganic acid is HCl.

In another embodiment, the additive is a mixture of hydrogen peroxide (H₂O₂) and a strong inorganic acid. Particularly, the additive is a mixture of H₂O₂ and HCl.

The solid used as input material in the extraction process is a mineral concentrate. The term “mineral concentrate” refers to refined ores from which the bulk of waste materials have been removed. The mineral concentrate is obtained after a previous pre-treatment of the mineral, including comminution, flotation, and some other steps well known by any person skilled in the art. As an example, mined ores can be processed through comminution and beneficiation in order to obtain streams enriched in the targeted metals or by products and/or to separate the metals in different streams. The objective of this processing stages is to facilitate the subsequent chemical steps to extract and recover the desired metals with the maximum yields possible. For example Comminution can be carried out by crushing or milling. On the other hand, beneficiation can be carried out by separation methods such as flotation or gravity separation obtaining finally a higher-grade product (concentrate). As used herein, the term “beneficiation” refers to any process that improves (benefits) the economic value of the ore by removing the gangue minerals, which results in a higher grade product (ore concentrate) and a waste stream (tailings).

Most of the by-products metals are Critical Raw Materials, that is highly demanded materials which are crucial to Europe's economy yet without reliable and unhindered access from the EU. Examples of by-products metals are, without being limited to, bismuth (Bi), silver (Ag), tellurium (Te), antimony (Sb), cadmium (Cd), Indium (In), gold (Au), germanium (Ge), cobalt (Co), and platinum (Pt), selenium (Se), molybdenum (Mo).

In an embodiment of the process of the present disclosure, optionally in combination with one or more features of the various embodiments described above or below, the by-product metal is selected from the group consisting of Bi, Ag, Te, Sb, and mixtures thereof. Particularly, the by-product metal is selected from Bi, Te and a mixture thereof.

As mentioned above, with the process of the invention, a joint recovery of by-products from primary sources that belong to the Cu—Ag—Au group is allowed. Thus, in another embodiment, optionally in combination with one or more features of the various embodiments described above, the by product metal is a mixture of Bi, Ag, Te, and Sb.

As mentioned above, the leaching solvent system used in the process of the invention comprises a deep eutectic solvent (DES) consisting of a mixture of an HBA which is a salt of formula (I), i.e., Cat⁺X⁻, as defined herein and an HBD selected from ethylene glycol, triethylene glycol, and glycerol.

In another embodiment, optionally in combination with one or more features of the various embodiments described above, the Cat⁺ cation is selected from the group consisting of (2-hydroxyethyl)trimethylammonium (choline, Ch), ethyl(2-hydroxyethyl)dimethylammonium, bis(2-hydroxyethyl)dimethylammonium, and methyl(2-hydroxyethyl)diethyl-ammonium.

In another embodiment, optionally in combination with one or more features of the various embodiments described above, the salt Cat⁺X⁻ of formula (I) is selected from the group consisting of choline chloride, choline bromide, choline iodide, choline fluoride, ethyl(2-hydroxyethyl)dimethylammonium chloride, methyl(2-hydroxyethyl)diethylammonium chloride, methyl(2-hydroxyethyl)diethylammonium bromide, benzyl(2-hydroxyethyl)dimethylammonium chloride, bis(2-hydroxyethyl)dimethylammonium chloride, bis(2-hydroxyethyl)dimethylammonium iodide and benzyl-bis(2-hydroxyethyl)methylammonium chloride.

In another embodiment, optionally in combination with one or more features of the various embodiments described above, in the DES used in the leaching solvent system, the Cat⁺ cation is choline.

In another embodiment, optionally in combination with one or more features of the various embodiments described above, X⁻ is a halide, in particular X⁻ is selected from Cl⁻ and Br⁻.

In another embodiment, optionally in combination with one or more features of the various embodiments described above, the salt Cat⁺X⁻ of formula (I) is choline chloride.

In another embodiment, optionally in combination with one or more features of the various embodiments described above, the HBD is ethylene glycol or glycerol.

In another embodiment, optionally in combination with one or more features of the various embodiments described above, the HBD is ethylene glycol.

In another embodiment, optionally in combination with one or more features of the various embodiments described above, the salt Cat⁺X⁻ of formula (I) is choline chloride and the HBD is ethylene glycol.

In another embodiment, optionally in combination with one or more features of the various embodiments described above, the HBA and the HBD are in a molar ratio from 1:5 to 5:1; more particularly, the molar ratio HBA:HBD is from 1:5 to 2:1, even more particularly from 1:3 to 1:1. In a particular embodiment, optionally in combination with one or more features of the various embodiments described above or below, the molar ratio HBA:HBD is 1:1, 1:2, 1:3, 1:4, or 1:5, more particularly 1:2.

In a more particular embodiment, optionally in combination with one or more features of the various embodiments described above, the DES used in leaching solvent system is choline chloride:ethylene glycol (ChCl:EG) in a molar ratio 1:2.

In another embodiment, optionally in combination with one or more features of the various embodiments described above, the weight ratio DES:mineral concentrate is from 4:1 to 60:1, particularly from 5:1 to 50:1, more particularly, from 5:1 to 20:1.

In another embodiment, optionally in combination with one or more features of the various embodiments described above, the additive is HCl. In a particular embodiment, HCl is at a concentration from 1 M to 10 M, such as of 6 M. In another particular embodiment, the HCl is in a concentration of 6 M, and it is added at a HCl (6M):mineral concentrate weight ratio from 1:0.5 to 5:1, particularly of 3:1, more particularly 2:1. An equivalent amount of HCl at other concentration could be used. Namely, if HCl at another concentration is used, the corresponding amount of HCl solution to obtain an equivalent amount of HCl will be added. Particularly, the process is performed at a pH of about 0 such as from 0 to 0.5.

In another embodiment, optionally in combination with one or more features of the various embodiments described above, the additive is hydrogen peroxide. In a particular embodiment, the hydrogen peroxide is 35% H₂O₂ at a H₂O₂ (35%):mineral concentrate weight ratio from 1:2 to 5:1, particularly from 1:1 to 5:1, more particularly from 2:1 to 3:1. An equivalent amount of H₂O₂ at other concentration could be used. Namely, if H₂O₂ at another concentration is used, the corresponding amount of H₂O₂ solution to obtain an equivalent amount of H₂O₂ will be added. The term “35% H₂O₂” refers to a 35 wt. % dilute solution in water.

In another embodiment, optionally in combination with one or more features of the various embodiments described above, the additive is a mixture of HCl and H₂O₂. In a particular embodiment, the HCl is at a concentration from 6 M, and it is at a HCl 6M:mineral concentrate weight ratio from 1:0.5 to 5:1, particularly of 3:1, more particularly of 2:1; and the hydrogen peroxide is 35% H₂O₂ at a 35% H₂O₂:mineral concentrate weight ratio from 1:2 to 5:1, particularly from 1:1 to 5:1, more particularly from 2:1 to 3:1. As mentioned above, if HCl at another concentration is used, the corresponding amount of HCl solution to obtain an equivalent amount of HCl could be added; and H₂O₂ at another concentration is used, the corresponding amount of H₂O₂ solution to obtain an equivalent amount of H₂O₂ will be added.

As mentioned above, by using the leaching solvent system of step b) it is possible to extract at least 50% w/w of a by-product metal from the mineral concentrate defined herein above and below. Particularly, in the conditions disclosed herein, the process allows the extraction of more than 60%, more than 70%, or more than 80% of a by-product metal such as Te, and of and more than 90% of a by-product metal such as Ag, and Bi.

In another embodiment, optionally in combination with one or more features of the various embodiments described above, step b) is carried out at a temperature from 20° C. to 75° C., in particular, from 25° C. to 70° C., more particularly from 25° C. to 50° C., under stirring, particularly at a stirring rate from 100 to 500 rpm.

In another embodiment, optionally in combination with one or more features of the various embodiments described above, the weight ratio DES:mineral concentrate is from 5:1 to 50:1, the additive is a mixture of HCl and H₂O₂, wherein the HCl is at a concentration of 6 M and at a HCl 6M:mineral concentrate weight ratio of equal or higher than 2:1 (or an equivalent amount of HCl at other concentration), such as from 1.5:1 to 3:1; and the H₂O₂ is 35% H₂O₂ at a 35% H₂O₂:mineral concentrate weight ratio equal or higher than 2:1 (or an equivalent amount of H₂O₂ at other concentration), such as from 1.5:1 to 3:1. In a particular embodiment, the DES used in the leaching solvent system, is a DES as defined above wherein the Cat⁺ cation is choline. In a more particular embodiment, the DES is choline chloride:ethylene glycol in a molar ratio 1:2.

Thus, the process of the present disclosure allows maximizing the extraction of by-product metals having a high commercial value, while minimizing the extraction of major metals, such as Fe, Cu, Zn, and, particularly, Pb, that can interfere in the recovery step of by-product metals by electrodeposition.

Some of the conditions most affecting the economic viability of the process are the DES:mineral concentrate, the leaching temperature, and the leaching time. The higher these are, the lower the economic viability of the process. Therefore, in an embodiment, the process is carried out at the following conditions:
DES:mineral concentrate weight ratio 5
HCl 6M:mineral concentrate weight ratio 2
35% H₂O₂:mineral concentrate weight ratio 3
Leaching T: 30° C.
Stirring: 500 rpm
Leaching time: 1 h

This process allows obtaining particularly high extraction yields of by-product metals.

The inventors also found that by increasing the relative amount of HCl and H₂O₂, and the leaching temperature and time not only allowed to increase the recovery percentage of the by-product metals in general, particularly of Ag, Bi, Te, Cd, In, and Sb (in some conditions Ag, Te, and Bi recovery is close or even above of 90%), but also major metals were recovered in unexpectedly high percentages.

Hence, in case of interest, the process of the present disclosure allows also to recover accompanying major metals, e.g. copper (Cu), iron (Fe), and zinc (Zn) may also be recovered by this process.

Accordingly, in another embodiment, optionally in combination with one or more features of the various embodiments described above, step b) is carried out for a time of higher than 1 h, such as from 8 h to 24 h, and at a temperature from 30° C. to 75° C., particularly from 58° C. to 70° C.; wherein the weight ratio DES:mineral concentrate is from 5:1 to 20:1; wherein the additive is a mixture of HCl and 35% H₂O₂, wherein the HCl is in an amount equivalent to the addition of 6 M HCl at a HCl (6M):mineral concentrate weight ratio higher that 2:1, such as of 3:1, and the H₂O₂ is in an amount equivalent to the addition of 35% H₂O₂ at a H₂O₂ (35%):mineral concentrate weight ratio higher that 2:1, such as of 3:1. In a particular embodiment, the DES used in the leaching solvent system, is a DES as defined above wherein the Cat⁺ cation is choline. In a more particular embodiment, the DES is choline chloride:ethylene glycol in a molar ratio 1:2.

Which such conditions leaching solvent system is capable of extracting at least 40% w/w of a major metal from the mineral concentrate such as of Fe, Cu, and Zn, and particularly more than 60% of some major metals such as Cu and Zn (see Table 4).

In a particular embodiment, optionally in combination with one or more features of the various embodiments described above, step b) is carried out for a time from 8 h to 24 h and at a temperature from 50° C. to 70° C.; wherein the weight ratio DES:mineral concentrate is from 5:1 to 20:1; wherein the additive is a mixture of HCl and 35% H₂O₂, wherein the HCl is in an amount equivalent to the addition of 6 M HCl at a HCl (6M):mineral concentrate weight ratio of 3:1, and the H₂O₂ is in an amount equivalent to the addition of 35% H₂O₂ at a H₂O₂ (35%):mineral concentrate weight ratio of 3:1.

In another particular embodiment, optionally in combination with one or more features of the various embodiments described above, the major metal is selected from copper (Cu), iron (Fe), zinc (Zn), and mixtures thereof.

In another particular embodiment, optionally in combination with one or more features of the various embodiments described above, the major metal is a mixture of Fe, Cu, and Zn, and at least 40% w/w of each metal is extracted from the mineral concentrate and, optionally, at least 60 wt. % of at least two major metals is extracted from the mineral concentrate.

The % of extraction as defined above referred to a metal such as a by-product metal or a major metal, also referred herein to as efficiency or percentage of the metal leached, can be determined by comparing: i) the content of the metal element that have been dissolved in the leaching solvent system after contacting the mineral concentrate with the leaching solvent system (step b) in the conditions defined herein, with ii) the content of the same metal in the mineral concentrate before being subjected to the leaching process.

The contents i) and ii) above can be determined by using inductive coupled plasma mass spectroscopy (ICP-MS), which is a technique well-known in the art. For example, these measurements can be carried out by using an ICP-MS spectrometrer such as e.g. the equipment Agilent 7900. The skilled person will know how to carry out the above measurements.

The % of extraction or efficiency of the process of the invention can be calculated by the following formula:

$$Efficiency = [ ( x * y ) / 1. \text{.000} ] / [ ( z * w ) / 1. \text{.000} ] * 100$$

wherein x is the concentration (in ppm) of the metal in the leaching solvent system as measured by ICP-MS; y is the amount in g of the sample of leaching solvent system; z is the concentration (in ppm) of the metal in the starting mineral concentrate as measured by ICP-MS; and w is the amount in g of the sample of mineral concentrate.

In another embodiment, optionally in combination with one or more features of the various embodiments described above, the process further comprises an additional step d) of recovering the by-product metal from the leachate. Such a recovery could be made by techniques such as precipitation, liquid-liquid extraction, electrodeposition, or electrowinning.

As mentioned above, another aspect of the invention relates to a leaching solvent system comprising a deep eutectic solvent (DES) as defined above and an additive selected from the group consisting of hydrogen peroxide (H₂O₂), a strong inorganic acid, and a mixture thereof. In particular, the strong inorganic acid is selected from the group consisting of hydrochloric acid (HCl), sulfuric acid (H₂SO₄), and nitric acid (HNO₃), and more particularly, the strong inorganic acid is HCl.

In another embodiment, the additive is a mixture of hydrogen peroxide (H₂O₂) and a strong inorganic acid. Particularly, the additive is a mixture of H₂O₂ and HCl.

All the definitions of the leaching solvent system used in the process of the present disclosure defining embodiments of the process also apply to the definition of leaching solvent system itself, namely, define specific embodiments of the leaching solvent system.

Throughout the description and claims the word “comprise” and variations of the word, are not intended to exclude other technical features, additives, components, or steps. Furthermore, the word “comprise” encompasses the case of “consisting of”.

The following examples are provided by way of illustration, and they are not intended to be limiting of the present invention. Furthermore, the present invention covers all possible combinations of particular and preferred embodiments described herein.

### EXAMPLES

### Example 1—Selective Leachinq of by-Product Metals

A leaching process was carried out on a mineral concentrate comprising the mineralogical composition shown in Table 1. The mineral concentrate can be obtained by any of the methods disclosed above.

TABLE 1

| Mineral concentrate | | Ag | Bi | Te | Sb | In | Cd | Pb | Fe | Cu | Zn |
|---|---|---|---|---|---|---|---|---|---|---|---|
| Galena | PbS | X* | X* | | | | | X | | | |
| Hessite | AgTe₂ | X | | X | | | | | | | |
| Tetrahedrite | (Cu,Fe)₁₂Sb₄S₁₃ | X* | | | X | | | | X | X | |
| Wittchinite | CuBiS₄ | | X | | | | | | | X | |
| Pilsinite | Bi₄Te₃ | | X | X | | | | | | | |
| Aleksite | PbBi₂Te₂S₂ | | X | X | | | | X | | | |
| Bismuthinite | Bi₂S₃ | | X | | | | | | | | |
| Sphalerite | ZnS | | | | | X* | X* | | | | X |
| Pyrite | FeS₂ | | | | | | | | X | | |
| Chalcopyrite | CuFeS₂ | | | | | | | | X | X | |

| | | | | | | | | | | |
|---|---|---|---|---|---|---|---|---|---|---|
| Concentration | >0.1% | 8296 ppm | 834 ppm | 3199 ppm | 71 ppm | 417 ppm | >30% | >5% | >5% | >5% |

*Present as inclusions.

Although not specified in Table 1, the mineral concentrate also contained Se, Co, and Mo in different mineral phases.

### Leaching Process Conditions and Ratios

The DES:concentrate mass ratio used was from 50 to 5.
The additive:concentrate mass ratio used was from 0 to 3 (considering the additive as the dissolution of HCl 6 M, not pure HCl).
The oxidant:concentrate mass ratio used was from 0 to 3 (considering the oxidant as the dissolution of 35% H₂O₂, not pure H₂O₂).
The leaching temperature was from 70° C. to 20° C.
The system was stirred at a constant stirring rate from 500 to 100 rpm.
The reaction time from 1 to 24 hours.

### Leaching Procedure

First, the 6 M HCl was added to the pure DES (ChCl/EG 1:2). The DES+HCl mixture was heated to the selected leaching temperature by introducing the reaction vessel in a metallic heating block. Once the solution reached the leaching temperature, the solid (concentrate) was incorporated to the system. Finally, the oxidant (35% H₂O₂) was added gradually to the mixture, so that the temperature increase, due to the exothermic reaction taking place, occurs in a controlled manner. The addition rate of the hydrogen peroxide was 0.075 ml·min⁻¹·g conc⁻¹.

Once the reaction finished, the residual solid was separated from the leachate by vacuum filtration. The solid impregnated with remaining DES was washed with distilled water and subsequently dried in the oven.

As shown in Table 2, with the process of the present disclosure, high recovery percentages of some by-product metals, particularly of Bi, Ag, Te, and Sb, and in some specific conditions, also relatively high percentage of other by-product metals such as Cd and In were achieved, with a significantly low recovery of major metals (Fe, Cu, Zn, and Pb). In Table 2 “S” means “solid”, i.e., mineral concentrate.

TABLE 2

| | | | | | | | Recovery (%) | | | | Recovery (%) | | | | | | | | | |
|---|---|---|---|---|---|---|---|---|---|---|---|---|---|---|---|---|---|---|---|---|
| Test | DES/S | H₂O₂/S | HCl/S | t (h) | T (° C.) | rpm | Fe | Cu | Zn | Pb | Se | Mo | Ag | Cd | In | Sb | Te | Au | Bi | Co |
| 1 | 50 | 3 | 2 | 9 | 70 | 218 | 27 | 37 | 35 | 6 | 3 | 0 | 93 | 43 | 40 | 54 | 64 | 0 | 96 | 0 |
| 2 | 50 | 2 | 0 | 24 | 70 | 500 | 5 | 2 | 5 | 6 | 24 | 0 | 65 | 12 | 7 | 46 | 73 | 0 | 75 | 0 |
| 3 | 50 | 1 | 3 | 1 | 70 | 500 | 14 | 17 | 20 | 4 | 2 | 0 | 61 | 24 | 20 | 26 | 35 | 0 | 69 | 0 |
| 4 | 50 | 0 | 3 | 22 | 70 | 147 | 6 | 4 | 11 | 4 | 7 | 0 | 89 | 19 | 7 | 35 | 30 | 0 | 96 | 0 |
| 5 | 5 | 1 | 3 | 24 | 29 | 294 | 13 | 13 | 17 | 6 | 0 | 0 | 55 | 22 | 16 | 30 | 6 | 0 | 77 | 15 |
| 6 | 5 | 3 | 0 | 24 | 29 | 500 | 7 | 6 | 6 | 10 | 9 | 1 | 40 | 13 | 9 | 36 | 55 | 0 | 65 | 11 |
| 7 | 5 | 3 | 2 | 1 | 29 | 500 | 18 | 24 | 31 | 13 | 12 | 1 | 81 | 36 | 28 | 34 | 84 | 2 | 97 | 36 |
| 8 | 50 | 0 | 2 | 12 | 44 | 364 | 5 | 3 | 2 | 3 | 5 | 0 | 53 | 7 | 3 | 16 | 25 | 0 | 47 | 0 |
| 9 | 50 | 2 | 2 | 24 | 44 | 100 | 16 | 17 | 17 | 3 | 3 | 0 | 60 | 22 | 20 | 29 | 26 | 0 | 67 | 0 |
| 10 | 20 | 2 | 2 | 14 | 48 | 334 | 20 | 23 | 24 | 2 | 1 | 0 | 67 | 30 | 28 | 31 | 3 | 0 | 79 | 14 |
| 11 | 20 | 1 | 2 | 12 | 48 | 276 | 15 | 15 | 16 | 2 | 1 | 0 | 53 | 21 | 19 | 22 | 3 | 0 | 69 | 27 |
| 12 | 50 | 3 | 3 | 24 | 20 | 402 | 12 | 13 | 30 | 4 | 5 | 1 | 72 | 34 | 23 | 35 | 81 | 0 | 87 | 0 |
| 13 | 20 | 3 | 2 | 13 | 20 | 100 | 11 | 13 | 17 | 3 | 32 | 1 | 64 | 22 | 15 | 24 | 65 | 0 | 70 | 15 |
| 14 | 20 | 1 | 3 | 12 | 20 | 500 | 9 | 8 | 17 | 2 | 3 | 0 | 62 | 21 | 13 | 23 | 16 | 0 | 72 | 15 |
| 15 | 20 | 2 | 3 | 1 | 58 | 166 | 21 | 29 | 28 | 4 | 5 | 1 | 63 | 34 | 31 | 26 | 38 | 0 | 77 | 15 |
| 16 | 5 | 0.65 | 2 | 1.75 | 50* | ** | 5 | 6 | 15 | 5 | 6 | 2 | 67 | 26 | 13 | 22 | 69 | 6 | 73 | 4 |

*Initial RT; exothermic reaction, reaches Tₘₐₓ = 50° C.;
** Optimized for proper fluid-dynamical properties of the reaction media.

In a particular example, as shown in Table 3, the process carried out at the following conditions (Test 7 in Table 2) allowed to obtain very good recovery percentages of some by-product metals, particularly Ag, Te, and Bi, with a minimum recovery of major metals (Fe, Cu, Zn, and Pb):
DES:mineral concentrate weight ratio 5
HCl 6M:mineral concentrate weight ratio 2
35% H₂O₂:mineral concentrate weight ratio 3
leaching T: 30° C.
Stirring: 500 rpm
leaching time: 1 h

TABLE 3

| | Recovery (%) | | | | Recovery (%) | | | | | | | | | |
|---|---|---|---|---|---|---|---|---|---|---|---|---|---|---|
| Test | Fe | Cu | Zn | Pb | Se | Mo | Ag | Cd | In | Sb | Te | Au | Bi | Co |
| 7 | 18 | 24 | 31 | 13 | 12 | 1 | 81 | 36 | 28 | 34 | 84 | 2 | 97 | 36 |

### Example 2—Concomitant Leachinq of Major Metals and by-Product Metals

By carrying out the process in some specific conditions, in addition to a high recovery of by-product metals, a relatively high recovery of major metals can be obtained. Particularly, as shown in Table 4 below, the process allows to extract higher amounts of Fe, Cu and Zn than in some processes of the prior art using similar leaching solvents (see for instance Mahajan, V. B. et. al., wherein no mention is made on the recovery of Zn, Fe and by-product metals; Ruiz-Sánchez, Á. et. al., wherein with EG plus H₂SO₄ less that 50% Cu and less than 35% Fe were dissolved; Petrovic, S. et al., wherein the maximum Cu extraction was 33%; and Carlesi, C. et al., wherein with Ch/EG less that 10% Cu was dissolved using a solid/DES ratio of 1/5, 50° C. and 240 min), while at the same time a very high recovery of some by-products metals such as Ag, Bi, Te, Cd, In, and Sb is achieved.

TABLE 4

| | | | | | | | Recovery (%) | | | | Recovery (%) | | | | | | | | | |
|---|---|---|---|---|---|---|---|---|---|---|---|---|---|---|---|---|---|---|---|---|
| Test | DES/S | H₂O₂/S | HCl/S | t (h) | T (° C.) | rpm | Fe | Cu | Zn | Pb | Se | Mo | Ag | Cd | In | Sb | Te | Au | Bi | Co |
| 16 | 5 | 3 | 3 | 24 | 70 | 100 | 43 | 61 | 65 | 12 | 1 | 1 | 94 | 73 | 64 | 52 | 88 | 4 | 96 | 22 |
| 17 | 20 | 3 | 3 | 24 | 58 | 500 | 44 | 66 | 65 | 5 | 1 | 1 | 88 | 70 | 72 | 45 | 100 | 10 | 90 | 23 |

S: solid (i.e., mineral concentrate)

### Comparative Examples 1 to 3

In order to see the effect of the different components of the leaching solvent system used in the process of the invention, a leaching process was carried out with the any one of the solvent systems shown in Table 5 in the following conditions:
DES=choline chloride:ethylene glycol (1:2)
T=30° C.
Stirring rate=500 rpm
Time=1 h
DES:mineral concentrate=5

TABLE 5

| | | | | Recovery (%) | | | | Recovery (%) | | | | | | | | | | |
|---|---|---|---|---|---|---|---|---|---|---|---|---|---|---|---|---|---|---|
| Test | Leaching system | H₂O₂/S | HCl/S | Fe | Cu | Zn | Pb | As | Se | Mo | Ag | Cd | In | Sb | Te | Au | Bi | Co |
| Comp. Ex. 1 | Aq. soln. | 3 | 2 | 8 | 6 | 19 | 2 | 19 | 3 | 1 | 3 | 22 | 13 | 25 | 28 | 0 | 64 | 15 |
| | EG + H₂O₂⁽¹⁾ + HCl⁽²⁾ | | | | | | | | | | | | | | | | | |
| Comp. Ex. 2 | H₂O + HCl⁽²⁾ + H₂O₂ | 3 | 2 | 6 | 6 | 9 | 2 | 12 | 4 | 2 | 2 | 13 | 9 | 19 | 33 | 0 | 54 | 10 |
| Comp. Ex. 3 | DES | 0 | 0 | 0 | 0 | 0 | 0 | 0 | 0 | 0 | 0 | 1 | 0 | 0 | 1 | 0 | 0 | 0 |
| Ex. 7 | DES + H₂O₂⁽¹⁾ + HCl⁽²⁾ | 3 | 2 | 18 | 24 | 31 | 13 | 8 | 12 | 1 | 81 | 36 | 28 | 34 | 84 | 2 | 97 | 36 |

⁽¹⁾35% H₂O₂
⁽²⁾HCl 6M

The results show that the DES alone or the additives without the DES, either in the presence or the absence of EG, provides a significantly lower leaching yield of the metals of interest compared with the leaching system of the invention comprising DES, HCl, and H₂O₂.

### CITATION LIST

### Non Patent Literature

1. Mahajan, V. B. et. al., “Enhanced leaching of copper from chalcopyrite in hydrogen peroxide-glycol system”. Minerals Engineering, 2007, vol. 20. 670-674; DOI: 10.1016/j.mineng.2006.12.016).
2. Ruiz-Sánchez, Á. et. al., “Improved Process for Leaching Refractory Copper Sulfides with Hydrogen Peroxide in Aqueous Ethylene Glycol Solutions: Proceedings of the First Global Conference on Extractive Metallurgy”. Extraction, 2018 (pp. 1289-1298); DOI: 10.1007/978-3-319-95022-8_105.
3. Petrovic, S. et al., “Leaching of chalcopyrite with hydrogen peroxide in hydrochloric acid solution”. Transactions of Nonferrous Metals Society of China, 2018, vol. 28. 1444-1455; DOI: 10.1016/S1003-6326 (18)64788-0.
4. Carlesi, C. et al., “Chemical Dissolution of Chalcopyrite Concentrate in Choline Chloride Ethylene Glycol Deep Eutectic Solvent”. Minerals. 2022, vol. 12. 65; DOI: 10.3390/min12010065.

What is claimed is:

1. A process for the extraction of a by-product metal from a mineral concentrate comprising a sulfide, selenide, or telluride mineral of the Cu—Ag—Au group, the process comprising the steps of:
a) providing a mineral concentrate comprising a sulfide, selenide, or telluride mineral of the Cu—Ag—Au group, wherein the sulfide, selenide, or telluride mineral comprises a by-product metal selected from the group consisting of Bi, Ag, Te, Se, Sb, Cd, In, Au, Ge, Co, Pt, Mo, and mixtures thereof;
b) contacting the mineral concentrate with a leaching solvent system comprising:
i) a deep eutectic solvent (DES) consisting of a mixture of
a hydrogen bond acceptor (HBA) of formula (I) 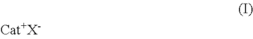
wherein
Cat⁺ is a cation selected from the group consisting of (2-hydroxyethyl)trimethylammonium (choline, Ch), ethyl(2-hydroxyethyl)dimethylammonium, benzyl(2-hydroxyethyl)dimethylammonium, bis(2-hydroxyethyl)dimethylammonium, benzyl-bis(2-hydroxyethyl)methylammonium, methyl(2-hydroxyethyl)diethyl-ammonium, (2-chloroethyl)trimethylammonium;
and X⁻ is an anion selected from the group consisting of F⁻, Cl⁻, Br⁻ and I⁻; and
a hydrogen bond donor (HBD) selected from ethylene glycol, triethylene glycol and glycerol;
wherein the HBA and the HBD are in a molar ratio from 1:10 to 10:1; and
ii) an additive selected from the group consisting of H₂O₂, a strong inorganic acid, and a mixture of H₂O₂ and the strong inorganic acid;
in order to obtain a leachate containing the by-product metal in dissolution; and
c) separating the leachate from the undissolved mineral concentrate.

2. The process of claim 1, wherein the by-product metal is selected from the group consisting of Bi, Ag, Te, Sb, and mixtures thereof; optionally, the by-product metal is a mixture of Bi, Ag, Te, Sb.

3. The process of claim 1, wherein in the DES solvent the molar ratio HBA:HBD is from 1:5 to 5:1.

4. The process of claim 1, wherein the DES is choline chloride:ethylene glycol in a molar ratio 1:2.

5. The process of claim 1, wherein the weight ratio DES:mineral concentrate is from 4:1 to 60:1.

6. The process of claim 1, wherein the additive is HCl.

7. The process of claim 6, wherein HCl is in an amount equivalent to adding 6 M HCl at a HCl (6M):mineral concentrate weight ratio from 1:0.5 to 5:1.

8. The process of claim 1, wherein the additive is hydrogen peroxide.

9. The process of claim 8, wherein the hydroxide peroxide is 35% H₂O₂ at a H₂O₂ (35%):mineral concentrate weight ratio from 1:2 to 5:1.

10. The process of claim 1, wherein the additive is a mixture of HCl and H₂O₂.

11. The process of claim 1, wherein step b) is carried out at a temperature from 20° C. to 75° C. under stirring.

12. The process of claim 1, wherein the weight ratio DES:mineral concentrate is from 5:1 to 50:1, the additive is a mixture of HCl and H₂O₂, wherein the HCl is in an amount equivalent to adding 6 M HCl at a HCl (6M):mineral concentrate weight ratio equal or higher than 2:1, and the H₂O₂ is in an amount equivalent to the addition of 35% H₂O₂ at a H₂O₂ (35%):mineral concentrate weight ratio equal or higher than 2:1.

13. The process of claim 1, wherein step b) is carried out for a time of higher that 1 h and at a temperature from 30° C. to 75° C.; wherein the weight ratio DES:mineral concentrate is from 5:1 to 20:1; wherein the additive is a mixture of HCl and H₂O₂, wherein the HCl is in an amount equivalent to adding 6 M HCl at a HCl (6M):mineral concentrate weight ratio higher that 2:1, and the H₂O₂ is in an amount equivalent to adding 35% H₂O₂ at a H₂O₂ (35%):mineral concentrate weight ratio higher that 2:1.

14. The process of claim 1, wherein the process further comprises an additional step d) of recovering the by-product metal from the leachate.

15. A leaching solvent system comprising:
i) a deep eutectic solvent (DES) consisting of a mixture of
a hydrogen bond acceptor (HBA) of formula (I) 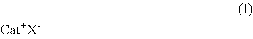
wherein
Cat⁺ is a cation selected from the group consisting of (2-hydroxyethyl)trimethylammonium (choline, Ch), ethyl(2-hydroxyethyl)dimethylammonium, benzyl(2-hydroxyethyl)dimethylammonium, bis(2-hydroxyethyl)dimethylammonium, benzyl-bis(2-hydroxyethyl)methylammonium, methyl(2-hydroxyethyl)diethyl-ammonium, (2-chloroethyl)trimethylammonium;
and X⁻ is an anion selected from the group consisting of F⁻, Cl⁻, Br⁻ and I⁻; and
a hydrogen bond donor (HBD) selected from ethylene glycol, triethylene glycol and glycerol;
wherein the HBA and the HBD are in a molar ratio from 1:10 to 10:1; and
ii) an additive selected from the group consisting of H₂O₂, a strong inorganic acid, and a mixture thereof.

16. The process of claim 1, wherein the strong inorganic acid is selected from the group consisting of hydrochloric acid, sulfuric acid, and nitric acid.

17. The process of claim 5, wherein the weight ratio DES:mineral concentrate is from 5:1 to 50:1, more particularly, from 5:1 to 20:1.

18. The process of claim 10, wherein HCl is in an amount equivalent to the addition of 6 M HCl at a HCl (6M):mineral concentrate weight ratio from 1:0.5 to 5:1; and the hydroxide peroxide is in an amount equivalent to the addition of 35% H₂O₂ at a H₂O₂ (35%):mineral concentrate weight ratio from 1:2 to 5:1

19. The process of claim 13, wherein step b) is carried out for a time from 8 h to 24 h and at a temperature from 50° C. to 70° C.; wherein the weight ratio DES:mineral concentrate is from 5:1 to 20:1; wherein the additive is a mixture of HCl and H₂O₂, wherein the HCl is in an amount equivalent to the addition of 6 M HCl at a HCl (6M):mineral concentrate weight ratio of 3:1, and the H₂O₂ is in an amount equivalent to adding 35% H₂O₂ at a H₂O₂ (35%):mineral concentrate weight ratio of 3:1.
